(19) United States
(12) Patent Application Publication
(10) Pub. No.: US 2020/0301759 A1
(43) Pub. Date: Sep. 24, 2020

(54) CHAINING OF BROKERED SERVICE INSTANCES

(71) Applicant: Hewlett Packard Enterprise Development LP, Houston, TX (US)

(72) Inventors: Kiran Kumar Vaddi, Bangalore Karnataka (IN); Lokesh Shivashankara, Bangalore Karnataka (IN); Bharath Kumar, Bangalore Karnataka (IN)

(21) Appl. No.: 16/356,171

(22) Filed: Mar. 18, 2019

(51) Int. Cl. G06F 9/54; G06F 11/14; G06F 8/65; H04L 29/06

(52) U.S. Cl. CPC G06F 9/54; G06F 11/1433; G06F 2201/84; H04L 63/083; G06F 8/65

(57) ABSTRACT

Example techniques for chaining of brokered service instances are described. In an example, a chaining instruction to chain a first service instance and a second service instance may be received. The first service instance may be provisioned by a first service broker and the second service instance may be provisioned by a second service broker. In response to the chaining instruction, an output parameter of the first service instance is received. Further, an input parameter is supplied to the second service broker based on the output parameter. The supplying of the input parameter facilitates chaining between the first service instance and the second service instance.

### BACKGROUND

A service may refer to a program that may perform a specialized operation. Examples of a service are a database service and a message queue. A service broker may provision an instance of a service to an application that is to use the service. For example, if an application is to use a database for storage of data of the application, a service broker corresponding to a database service may provision an instance of a database service to the application to allow the application to interface with the database.

### BRIEF DESCRIPTION OF DRAWINGS

The following detailed description references the figures, wherein:

FIG. 1 illustrates a system for chaining brokered service instances, according to an example implementation of the present subject matter.

FIG. 2 illustrates a computing environment in which service instances provisioned by service brokers are chained for utilization by an application, according to an example implementation of the present subject matter.

FIG. 3 illustrates chaining of brokered service instances by a system, according to an example implementation of the present subject matter.

FIG. 4 illustrates a method for chaining brokered service instances, according to an example implementation of the present subject matter.

FIG. 5 illustrates a method for chaining brokered service instances, according to an example implementation of the present subject matter.

FIG. 6 illustrates a computing environment, implementing a non-transitory computer-readable medium for facilitating chaining brokered service instances, according to an example implementation of the present subject matter.

### DETAILED DESCRIPTION

An application may utilize a plurality of services for its operation. For example, a web application may utilize a database service for storage of content of the web application and another service for retrieval of the content and presentation of the content on a web browser. A service for utilization by the application may be provisioned by a service broker corresponding to the service. A service provisioned by a service broker to an application may be referred to as a service instance, as the service broker may provision other instances of the same service to other requesting applications. Further, each service instance, being provisioned by a service broker, may be referred to as a brokered service instance.

In some cases, an output of a first service instance utilized by an application may have to be provided as an input to a second service instance utilized by the application. For example, in case of the web application, the content stored in the database is to be retrieved by the other service instance for display on the web browser. Accordingly, the service instances utilized by the application may have to be linked.

Generally, the linking of the various service instances involves significant manual intervention. For instance, a developer of the application may have to invoke the first service instance by interacting with a first service broker corresponding to the first service instance and obtain output parameters of the first service instance. The developer may then have to write a configuration file based on the output parameters. Subsequently, the developer may have to invoke a second service instance by interacting with a second service broker and supply the configuration file as input to the second service broker. Based on the configuration file, the second service may connect to the first service. Further, each service that is to be utilized by the application may have to be managed, such as updated, deleted, and the like, separately. Thus, development of applications using multiple brokered service instances may be laborious and inefficient.

The present subject matter relates to chaining of brokered service instances. With the implementations of the present subject matter, multiple brokered service instances utilized by an application can be chained in an automated and an efficient manner.

In accordance with an example implementation, a chaining instruction may be received to chain a first service instance to be provisioned by a first service broker and a second service instance to be provisioned by a second service broker. The first service instance and the second service instance may have to be chained for utilization by an application. The chaining instruction may be provided, for example, by a developer of the application. Based on the chaining instruction, the first service broker may be instructed to provision the first service instance and the second service broker may be instructed to provision the second service instance.

A first output parameter of the first service may be received, for example, from the first service instance. The first output parameter may be a connection parameter that can be used, for example, by the second service instance to connect to the first service instance. The connection parameter may be, for example, a uniform resource locator (URL) of the first service instance, a user identifier (ID) to access the first service instance, and a password to access the first service instance. A first input parameter may be supplied, for example, to the second service broker, which is to provision the second service instance. The first input parameter may include at least a part of the first output parameter. The second service broker may then provide the first input parameter to the second service instance upon provisioning of the second service instance. Accordingly, the supply of the first input parameter to the second service broker facilitates chaining the first service instance and the second service instance.

The chaining of the first service instance and the second service instance may allow managing them together. For example, an instruction to perform a lifecycle operation for the application may be received. The lifecycle operation may be, for example, an update operation or a delete operation. In response to the instruction, the lifecycle operation may be performed for both the first service instance and the second service instance.

The present subject matter provides an automated and efficient technique for chaining of brokered service instances. For instance, the instantiation of service instances and the supply of output parameters of one service instance as input parameters to another service instance in response to receiving a chaining instruction provides a simplified manner of chaining services that are to be utilized by an application. Thus, the present subject matter enables a developer to specify the service instances to be chained for an application in a declarative manner, and accordingly chains the service instances. Also, the present subject matter prevents the developer from having to write separate configuration files for each service instance that is to be involved in an application.

Further, the present subject matter enables managing all services utilized by an application together.

Example implementations of the present subject matter are described with regard to a web application. However, it will be understood that the implementations of the present subject matter can be used for any application that utilizes a plurality of service instances. For instance, the present subject matter can be used for development of multi-tiered applications, i.e., applications developed and distributed across more than one layer. An example of such an application is an application developed on a LAMP (Linux®, Apache®, MySQL®, PHP) web development platform.

The following description refers to the accompanying drawings. Wherever possible, the same reference numbers are used in the drawings and the following description to refer to the same or similar parts. While several examples are described in the description, modifications, adaptations, and other implementations are possible and are intended to be covered herein.

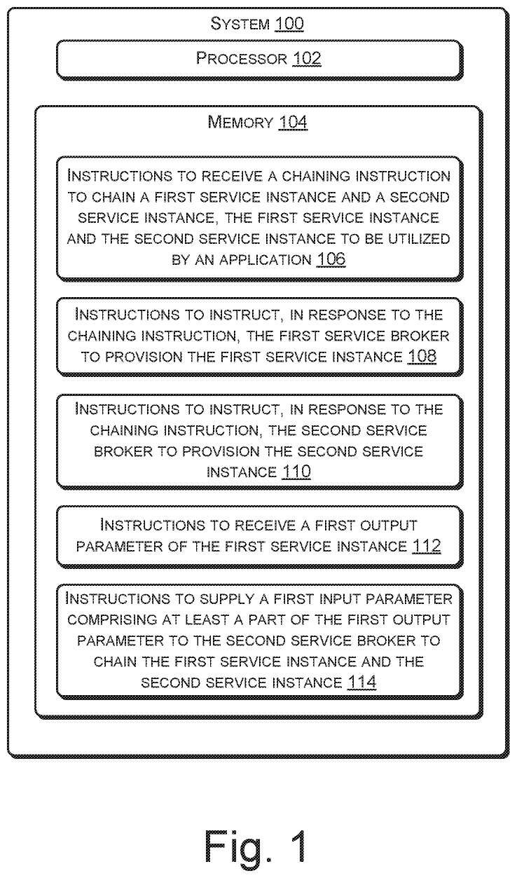

FIG. 1 illustrates a system 100 for chaining brokered service instances, according to an example implementation of the present subject matter. The system 100 may be implemented as any of a variety of computing systems, such as a desktop computer, a laptop computer, a server, and the like. The system 100 includes a processor 102 and a memory 104 coupled to the processor 102.

The processor 102 may be implemented as microprocessors, microcomputers, microcontrollers, digital signal processors, central processing units, state machines, logic circuitries, and/or any devices that manipulate signals based on operational instructions. Among other capabilities, the processor 102 may fetch and execute computer-readable instructions included in the memory 104. The computer-readable instructions, hereinafter referred to as instructions, include instructions 106-114. The functions of the processor 102 may be provided through the use of dedicated hardware as well as hardware capable of executing machine readable instructions.

The memory 104 may include any non-transitory computer-readable medium including volatile memory (e.g., RAM), and/or non-volatile memory (e.g., EPROM, flash memory, Memristor, etc.). The memory 104 may also be an external memory unit, such as a flash drive, a compact disk drive, an external hard disk drive, or the like.

In addition to the processor 102 and the memory 104, the system 100 may also include interface(s) and system data (not shown in FIG. 1). The interface(s) may include a variety of machine readable instructions-based interfaces and hardware interfaces that allow interaction with a user and with other communication and computing devices, such as network entities, web servers, and external repositories, and peripheral devices. The system data may serve as a repository for storing data that may be fetched, processed, received, or created by the instructions.

In operation, the system 100 may receive a chaining instruction to chain a first service instance with a second service instance for utilization by an application. The receipt of the chaining instruction may be facilitated by the instructions 106. The service instances to be utilized by an application may be interchangeably referred to as service instances for the application or service instances involved in the application. The first service instance may be provisioned by a first service broker and the second service instance may be provisioned by a second service broker.

In response to the chaining instruction, the system 100 may instruct the first service broker to provision the first service instance. For instructing the first service broker, the system 100 may utilize the instructions 108. Hereinafter, the terms “provisioning a service instance” and “instantiating a service instance” may be used interchangeably. Further, the system 100 may instruct the second service broker to instantiate the second service instance. For instructing the second service broker, the system 100 may utilize the instructions 110.

Further, the system 100 may receive, using the instructions 112, a first output parameter of the first service instance. The first output parameter may be provided by the first service instance upon its instantiation, and may be information using which another service instance, such as the second service instance, can connect to the first service instance. Alternatively, the first output parameter may be provided by the first service broker. The second service instance may have to connect to the first service instance for exchanging data with the first service instance. The first service instance and the second service instance may have to exchange data between each other during operation of the application.

The system 100 may then supply, using the instructions 114, a first input parameter to the second service broker. The first input parameter includes at least a part of the first output parameter. The first input parameter may be supplied by the second service broker to the second service instance upon instantiation of the second service instance. Using the first input parameter, the second service instance can connect to the first service instance, thereby enabling chaining between the first service instance and the second service instance.

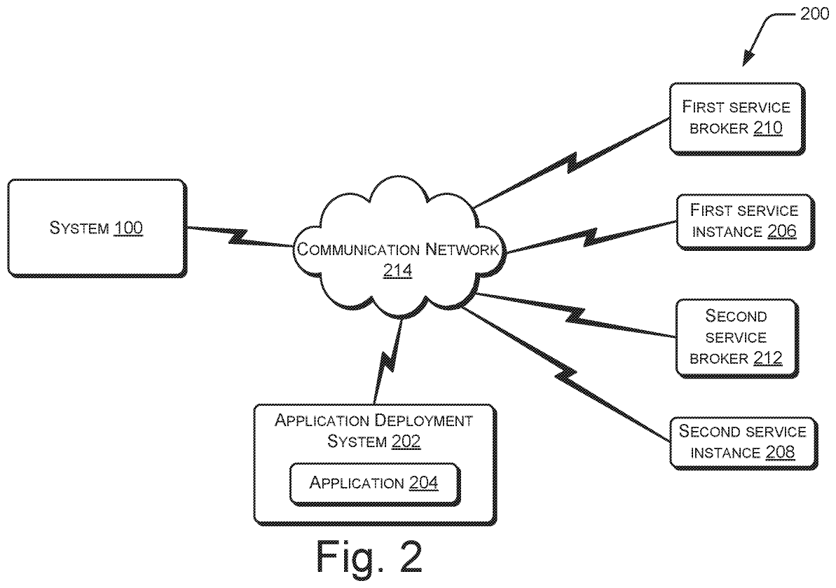

FIG. 2 illustrates a computing environment 200 in which service instances provisioned by service brokers are chained for utilization by an application, according to an example implementation of the present subject matter. As illustrated, the computing environment 200 may include an application deployment system 202 in which an application 204 is to be deployed. The application deployment system 202 may be, for example, a computing node, also referred to as a node. A node may be a computing device (e.g., a personal computer, a laptop, or a desktop) or a virtual machine (VM) running on a computing device. In another example, the application deployment system 202 may be a cluster of nodes, also referred to as a cluster. The cluster may refer to a set of nodes which have their resources, such as storage, processor, and memory, managed together. For instance, the application 204 may include several sub-applications, and the sub-applications may be distributed across the computing nodes of the cluster. The coordination of the sub-applications running on the different nodes may be performed by an orchestration platform, such as Kubernetes®. When the orchestration platform is Kubernetes®, the application deployment system 202 may be referred to as a Kubernetes® cluster.

An application, such as the application 204, may refer to a program or a group of programs designed to perform a function or a group of coordinated functions for a user. The application 204 may be, for example, a web application, which may be an application stored on a server and delivered over the Internet to the user through a web browser. The web application may be developed, for example, using WordPress®. The application 204 may have to perform several functions. For instance, a web application may have to store content in a database, receive a request for the content from the user, retrieve the content from the database, and present the content to the web browser. The database may be, for example, a database managed using a relational database management system (RDBMS) that uses Structured Query Language (SQL). Further, the receipt of request, retrieval of the content, and presentation of the content may be performed using a hypertext preprocessor (PHP) language, which is a server-side scripting language for creating dynamic web pages.

In some cases, at least some functions of the application 204 may be performed by services, such as a first service 206 and a second service 208, that are external to the application 204. For instance, referring to the example of web application, the database and a PHP service (a service that receives the request, retrieves content, and presents the content using the PHP language) may each be provided as a service external to the application 204. Accordingly, the first service 206 may be a database service and the second service 208 may be a PHP service. The utilization of an external service by the application 204 may be managed by a service broker corresponding to the external service. The service broker corresponding to the first service 206 may be referred to as a first service broker 210 and the service broker corresponding to the second service 208 may be referred to as a second service broker 212.

In an example, the first service broker 210 and the first service instance 206 may be deployed in a first service system (not shown in FIG. 2), and the second service broker 212 and the second service instance 208 may be deployed in a second service system (not shown in FIG. 2). Each of the first service system and the second service system may include one or more computing devices.

To utilize a service provided by a service broker, a request may be made to the service broker for the service. Subsequently, the service broker provisions the service to the application 204 and enables connection of the service to the application 204 (also referred to as “binding”). The service broker may also provision a similar service to another requesting application. For example, if the first service broker 210 corresponds to a database service, the first service broker 210 may provide the database service to another application (not shown in FIG. 2) as well. Accordingly, a service provided by a service broker to an application may be referred to as a service instance. Thus, the first service 206 will be hereinafter referred to as the first service instance 206 and the second service 208 will be hereinafter referred to as the second service instance 208. Further, the first service instance 206 and the second service instance 208, being provided by service brokers, may also be referred to as brokered service instances.

The provisioning of service instances by the service brokers for an application prevents an application developer from having to develop and manage the services that are to perform functions of the application. In an example, each service broker, such as the first service broker 210 and the second service broker 212, utilized by the application 204 may be compliant with a particular Application Programming Interface (API). Accordingly, the application deployment system 202 may communicate with all the service brokers using the API. The API may be, for example, an Open Service Broker (OSB) API, which is widely used to enable applications to utilize brokered service instances.

Although the provisioning of brokered service instances for applications simplify development of an application, however, the development of an application that is to utilize a plurality of service instances still involves a significant intervention of the developer.

In some cases, the first service instance 206 and the second service instance 208, which are to be utilized by the application 204, may have to interact with each other. For instance, referring to the earlier example of the web application, the PHP service instance may have to retrieve the content stored in the database for presenting to the web browser. To facilitate interaction between the first service instance 206 and the second service instance 208, generally, the developer may have to write a configuration file that links the two service instances. The configuration file may be, for example, a file having values of input parameters for the second service instance 208. For writing the configuration file, first, the developer may have to determine various parameters that will be output by the first service instance 206 by interacting with the first service broker 210, request the first service broker 210 to provision the first service instance 206, and receive the various parameters output by the first service instance 206 upon its provisioning. The various parameters may include parameters that specify how the first service instance 206 can be connected to. The developer may then have to determine parameters that are to be input to the second service instance 208, write the configuration file based on the parameters output by the first service instance 206 and the parameters to be input to the second service instance 208, and request the second service broker 212 to provision the second service instance 208. Thereafter, the developer may have to transmit the configuration file to the second service instance 208, using which the second service instance 208 may then connect to the first service instance 206. Further, if the application 204 is to utilize a third service instance (not shown in FIG. 2) that is to connect to the second service instance 208, the developer may have to write configuration file for the third service instance.

The system 100 significantly reduces the manual intervention in the development of the applications utilizing a plurality of service instances. In an example, the system 100 may be part of or may be the same as the application deployment system 202. In another example, as illustrated in FIG. 2, the system 100 and the application deployment system 202 may be connected through a communication network 214. For instance, the system 100 may be part of a Software as a Service (SaaS) portal external to the application deployment system 202. In both the above examples, the first service broker 210 and the second service broker 212 may be connected to the system 100 and the application deployment system 202 over the communication network 214.

The communication network 214 may be a wireless or a wired network, or a combination thereof. The communication network 214 may be a collection of individual networks, interconnected with each other and functioning as a single large network (e.g., the internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 214 includes various network entities, such as transceivers, gateways, and routers.

In an example, the system 100 may mediate between the application deployment system 202 and the service brokers that are to provision service instances to be utilized by the application 204. The system 100 may mediate for provisioning of the service instances and for chaining of the service instances.

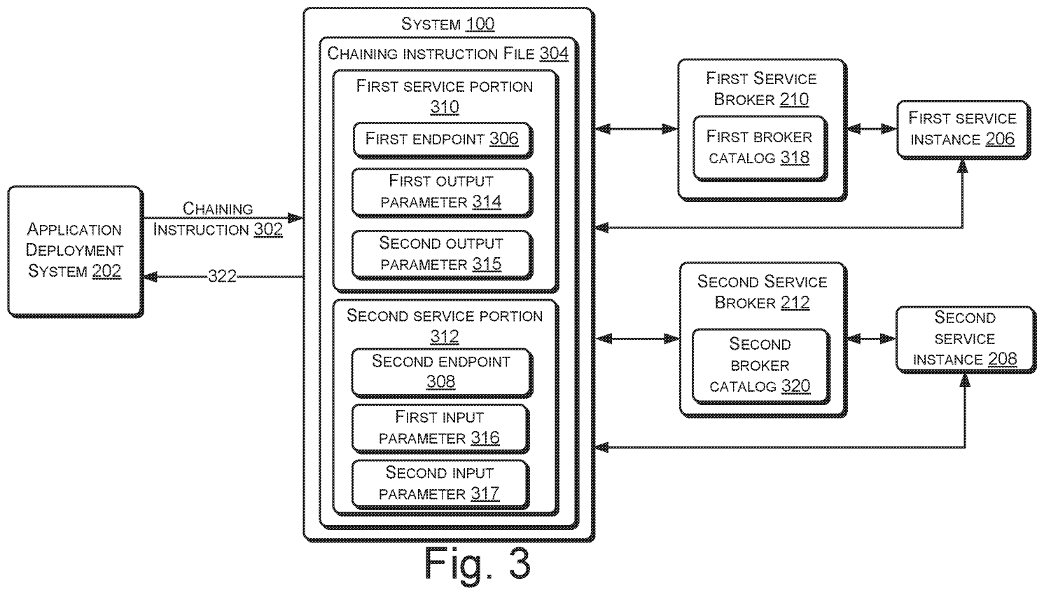

FIG. 3 illustrates chaining of brokered service instances by the system 100, according to an example implementation of the present subject matter. Here, chaining of service instances may refer to establishment of a connection between the service instances such that the services can interact and exchange data among themselves. The system 100 may initiate chaining of brokered service instances upon receiving a chaining instruction 302. The chaining instruction 302 may indicate the service instances, such as the first service instance 206 and the second service instance 208, that are to be chained for utilization by the application 204. The chaining instruction 302 may be provided, for example, by the developer of the application 204 from the application deployment system 202 and may be provided in a chaining instruction file 304. The chaining instruction file 304 may be in a markup language format, such as JavaScript® Object Notation (JSON) format or YAML Ain′t Markup Language (YAML) format.

In an example, to instruct the chaining of the first service instance 206 and the second service instance 208, the chaining instruction 302 may specify the service brokers that provision the service instances, i.e., the first service broker 210 and the second service broker 212. A service broker may be specified, for example, by specifying an endpoint of the service broker. The endpoint may include information like an Internet Protocol (IP) address and a Transmission Control Protocol (TCP) port of the service broker. An endpoint of the first service broker 210 may be referred to as a first endpoint 306 and an endpoint of the second service broker 212 may be referred to as a second endpoint 308.

In addition to specifying the list of service brokers, the chaining instruction 302 may also indicate an order in which the service instances provisioned by the service brokers are to be chained. In an example, the order may be an order in which data is to flow between services during operation of the application 204. For instance, referring to the web application example, when the first service instance 206 is a database and the second service instance 208 is a PHP service instance, the content stored in the database may have to be obtained by the PHP service instance. Accordingly, in the chaining instruction 302, the first service instance 206 may be specified first, and the second service instance 208 thereafter. This is illustrated in the chaining instruction file 304, in which a first service portion 310, which corresponds to the first service instance 206, is specified above a second service portion 312, which corresponds to the second service instance 208.

In response to receiving the chaining instruction 302, the system 100 may communicate with the service brokers specified in the chaining instruction 302 and instruct them to instantiate the service instances. The system 100 may instruct the service brokers in an order as specified in the chaining instruction 302. For example, since the first service portion 310 is specified above the second service portion 312 in the chaining instruction file 304, the system 100 may instruct the first service broker 210 first and instruct the second service broker 212 subsequently.

In an example, upon its instantiation, the first service instance 206 may provide a plurality of output parameters corresponding to the first service instance 206. Alternatively, the plurality of output parameters may be provided by the first service broker 210. An output parameter may be a parameter fetched from the response of a service call. The plurality of output parameters may include connection parameters, which are parameters that can be used to connect to the first service instance 206. The connection parameters include a first output parameter 314 and a second output parameter 315. The connection parameters may be, for example, a uniform resource locator (URL) of the first service instance 206, a user identifier (ID) for accessing the first service instance 206, and a password for accessing the first service instance 206. The first service instance 206 may have the user ID and the password to prevent its unauthorized access. For instance, when the first service instance 206 is a database, the presence of the user ID and the password ensures that the contents of the database cannot be accessed by unauthorized services. In an example, each output parameter may be received in the form of a key-value pair. For example, for the parameter of user ID, a key may be “user_ID”, and a value corresponding to the key may be “alpha”. Accordingly, the first output parameter 314 may be interchangeably referred to as the first key-value pair 314, having a first key (“user_ID”) and a first value (“alpha”).

Since the second service instance 208 is to connect to the first service instance 206, and the connection to the first service instance 206 is to be performed using the connection parameters, the second service instance 208 may be supplied with a plurality of input parameters corresponding to the connection parameters of the first service instance 206. The input parameters may be supplied by the system 100 to the second service broker 212, which may supply them to the second service instance 208. An input parameter may include at least a part of a connection parameter of the first service instance 206. For example, a first input parameter 316 includes at least a part of the first output parameter 314 and a second input parameter 317 includes at least a part of the second output parameter 315. Similar to the first output parameter 314, the first input parameter 316 may also be a key-value pair, and may be interchangeably referred to as the second key-value pair 316.

In an example, the system 100 may determine the keys of the output parameters of the first service instance 206 and the keys of the input parameters of the second service instance 208 based on catalogs of the respective service brokers. A catalog of a service broker may provide details of a service instance that can be provisioned by the service broker. The details may include keys of the input parameters of the service instance, keys of output parameters of the service instance, and service plans (e.g., small, medium, and large) in which a service instance may be provisioned. A catalog of the first service broker 210 may be referred to as a first broker catalog 318 and a catalog of the second service broker 212 may be referred to as a second broker catalog 320. The system 100 may receive the catalog of a service broker using a standard command, such as a “GET/v2/catalog” command.

In an example, the system 100 may perform a correspondence between output parameters of the first service instance 206 and input parameters of the second service instance 208 based on a comparison between their respective keys. For instance, a key of the first output parameter 314 (“the first key”) may be same as a key of the first output parameter 314. For instance, the key of the first output parameter 314 and the key of the first input parameter 316 may both be “user_ID”, the system 100 may deduce that the first output parameter 314 corresponds to the first input parameter 316.

However, in some cases, a key of an output parameter of the first service instance 206 may not match with a key of any of the input parameters of the second service instance 208. In such cases, the system 100 may determine a correspondence between parameters based on similarity in the keys. To detect the similarity in the keys, the system 100 may utilize a pattern matching technique. For instance, the key of the first output parameter 314 may be “user_ID”, while the key for the first input parameter 316 may be “DB_user_ID”. Since the keys are similar, the system 100 may deduce that the first output parameter 314 corresponds to the first input parameter 316. When the key of the first input parameter 316 is different from that of the first output parameter 314, the key of the first input parameter 316 may be referred to as a second key.

The determination of a correspondence between the output parameters of the first service instance 206 and the input parameters of the second service instance 208, as explained above, may be referred to as mapping of the output parameters and the input parameters.

Upon determining a correspondence between an output parameter and an input parameter based on keys, when the value of an output parameter is received from the first service instance 206, the system 100 may update the value of the corresponding input parameter. For example, upon receiving a first value of the first output parameter 314 from the first service instance 206, the system 100 may update a value of the first input parameter 316 with the first value. When the first key, i.e., the key of the first output parameter 314, is same as the second key, the first output parameter 314 is same as the first input parameter 316. When the first key is different from the second key, the first output parameter 314 may be slightly different from the first input parameter 316, as their keys are different, while their values are the same. Accordingly, it may be noted that the first input parameter 316 includes at least a part of the first output parameter.

The plurality of input parameters may be supplied by the system 100 to the second service broker 212, and the second service broker 212 may supply them to the second service instance 208 upon instantiation of the second service instance 208. In the below description, the supply of the input parameters from the system 100 to the second service broker 212 and from the second service broker 212 to the second service instance 208 will be collectively referred to as supply of the input parameters to the second service instance 208. Further, the system 100 may send an instruction to the second service broker 212 to instantiate the second service instance 208 before or after receiving the plurality of output parameters from the first service instance 206.

In an example, the transmission of the input parameters to the second service instance 208 based on the output parameters of the first service instance 206 may be performed using the chaining instruction file 304. The usage of the chaining instruction file 304 and transmission of parameters will be explained below:

Upon receiving the chaining instruction file 304 having the chaining instruction 302, the system 100 may first determine keys of the input parameters and keys of the output parameters of the first service instance 206 using the first broker catalog 318, as explained above. The system 100 may then update the chaining instruction file 304 with keys of the input parameters and keys of the output parameters and may determine a correspondence among the parameters. Subsequently, the system 100 may instruct the first service broker 210 to instantiate the first service instance 206. In an example, to instruct instantiation of the service instance, the system 100 may also specify a service plan (e.g., small, medium, or large) for the service instance. Further, in an example, for instructing the first service broker 210, the system 100 may utilize a standard command, such as a “PUT/v2/service_instancest instance_id” command. The input parameters may be supplied in a format that is acceptable to the first service instance 206. In an example, the format in which the input parameters is to be sent may be specified by the API using which the system 100 is to interact with the service brokers and the service instances. As mentioned earlier, the API may be OSB API.

Upon instantiating the first service instance 206, the output parameters received from the first service instance 206 may be populated in the chaining instruction file 304. For example, the values of the keys received from the first service instance 206 may be written to the chaining instruction file 304. The keys and values of the output parameters may be provided in the first service portion 310 of the chaining instruction file 304. This is illustrated by the provision of the first output parameter 314 and the second output parameter 315 in the first service portion 310.

The system 100 may also update the chaining instruction file 304 with keys of the input parameters and output parameters of the second service instance 208. The keys may be updated in the second service portion 312. Further, the system 100 may map the output parameters of the first service instance 206 and the input parameters of the second service instance 208 based on comparison of the keys, as explained earlier. Based on the comparison, the system 100 may update the values of the input parameters in the second service portion 312. This is illustrated by the provision of the first input parameter 316 and the second input parameter 317 in the second service portion 312. Subsequently, the system 100 may transmit the first input parameter 316 and other input parameters to the second service broker 212. The input parameters may be sent in a format that is acceptable to the second service instance 208. The format may be specified, for example, by OSB API standard. Based on the input parameters, the second service instance 208 may connect to the first service instance 206. This causes the chaining of the first service instance 206 and the second service instance 208. For instance, using the URL, the user name, and the password of the database, the PHP service can access the contents stored in the database.

Thereafter, the output parameters provided by the second service instance 208 may be received by the system 100. If, based on the chaining instruction 302, the system 100 determines that another service instance is to connect to the second service instance 208, the system 100 may cause instantiation of the other service instance, and may send the output parameters to service broker of the other service instance, in the manner as explained above. Otherwise, if the second service instance 208 is to be the last service instance on the chain of service instances to be utilized by the application 204, the system 100 may provide the output parameters of the second service instance 208 to the application deployment system 202, as illustrated by the arrow 322. For instance, if the application 204 is a web application and the second service instance 208 is a PHP service instance, the system 100 may provide the output parameters of the second service instance 208 to the application 204, using which the application 204 can connect to the PHP service instance. In an example, the output parameters of the PHP service instance may include an endpoint of the PHP service instance, a user ID for accessing the PHP service instance, and a password for accessing the PHP service instance. Thereafter, during operation of the web application, the data in the database can be accessed by the PHP service instance and presented on a web browser, upon receiving a request from a user. As another example, the first service instance 206 may provide stock price of a particular stock as time series data and the second service instance 208 may predict future value of the stock based on the time series data. Accordingly, the chaining of the two services may provide predicted future value of stock to the application 204.

In an example, the chaining instruction file 304 may be in a JSON format. An example chaining instruction file 304 in the JSON format is shown below:

{

“first_service_broker”: {

“endpoint”: “http://firstservicebroker.com”,
“index”: 0,
“credentials”: {

“auth_type”: “basic”,
“userID”: “alpha”
“password”: “vaultkey”

}

}

“second_service_broker”: {

“endpoint”: “http://secondservicebroker.com”,
“index”: 1,
“credentials”: {

“endpoint”: “http://myphpservice.com”,
“auth_type”: “basic”,
“userID”: “alpha”
“password”: “vaultkey”

}

}

}

In the above chaining instruction file 304, index values of service brokers may indicate the order in which the service instances provisioned by the service brokers are to be executed. For example, since the index value of the first service broker 210 is zero, the first service instance 206, provisioned by the first service broker 210, is to run first. Similarly, since the index value of the second service broker 212 is one, the second service instance 208 is to run second. Further, the credentials in the chaining instruction file 304 may be the connection parameters.

In the chaining instruction file 304, the developer may have provided the endpoints of the first service broker 210 and the second service broker 212, i.e., the first endpoint 306 and the second endpoint 308 alone, while the credentials, which may be the connection parameters, may be dynamically populated by the system 100 in the manner as explained above. The connection parameters may be provided in a credentials portion corresponding to the first service broker 210, as illustrated in the above chaining instruction file 304.

The population of the chaining instruction file 304 with the keys and values of the parameters of the services and transmission of the parameters from the chaining instruction file 304, as explained above, provides a dynamic manner of establishing a connection between service instances. Further, since the keys are determined based on catalogs of the service brokers and values are obtained from the service instances, the present subject matter ensures that up-to-date input parameters can be supplied to the service instances. Overall, the present subject matter provides a dynamic manner of chaining of services utilized by applications.

In an example, the first service instance 206 and the second service instance 208 may receive their respective input parameters as environment variables. An environment variable is a variable whose value is set outside a program that is to use the value. The value may be set using functionality built into an operating system of a computing device (not shown in FIG. 2) on which the service instance is running.

Since the service instances for an application are chained, in an example, the service instances may also be managed together. For example, the system 100 can perform a lifecycle operation for all service instances utilized by an application in response to a single instruction to perform lifecycle operation for the application. The management of the service instances together may also be referred to as collective management of service instances.

A lifecycle operation of a service may include, for example, update of the service instance and deletion of the service instance. Thus, when the system 100 receives an instruction to perform a delete operation for the application 204, for example, from the application deployment system 202, the system 100 may instruct the first service broker 210 and the second service broker 212 to de-provision the first service instance 206 and the second service instance 208 respectively. The application deployment system 202 may instruct deletion, for example, if the application 204 is to be deleted.

Similarly, when the system 100 receives an instruction to perform an update for the application 204, the system 100 may update the first service instance 206 from an earlier version of the first service instance 206 to a later version of the first service instance 206, and may update the second service instance 208 from an earlier version of the second service instance 208 to a later version of the second service instance 208. To update the first service instance 206 and the second service instance 208, the system 100 may instruct the first service broker 210 and the second service broker 212. The system 100 may instruct the first service broker 210 and the second service broker 212 in the order they are chained, i.e., instruct the first service broker 210 before the second service broker 212.

In an example, if, upon update of the first service instance 206, the update of the second service instance 208 fails, the system 100 may detect if the later version of the first service instance 206 is incompatible with the earlier instance of the second service instance 208. In response to detecting such an incompatibility, the system 100 may roll-back the update of the first service instance 206.

The system 100 may also facilitate password management for the application. For instance, upon chaining of the services based on the passwords provided as output parameters provided by the service instances, the developer may have to update a password for the first service instance 206, for example, to improve security of the first service instance 206. In such a case, the developer may provide an instruction to the system 100 to update the password and specify the new password for the first service instance 206. Accordingly, the system 100 may instruct the first service instance 206 to update its password and, in response to the update, the system 100 may update the new password of the first service instance 206 in the chaining instruction file 304. Further, the system 100 may supply the new password of the first service instance 206 to the second service instance 208, so that the second service instance 208 can maintain its connection with the first service instance 206. Therefore, the system 100 ensures that the service instances remain chained even if passwords of any of the service instances are updated.

The management of the chained service instances together provides a simplified and more efficient management of the services. Further, the collective management of the services prevents incompatibility between the services.

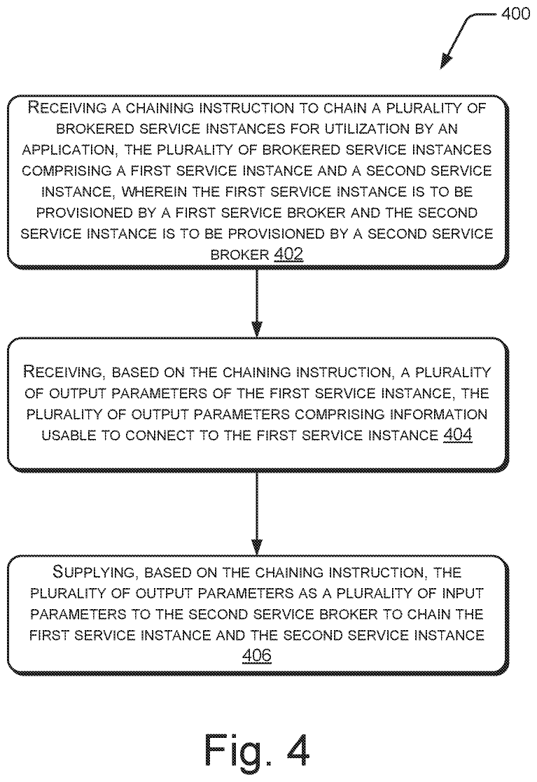

FIG. 4 illustrates a method 400 for chaining brokered service instances, according to an example implementation of the present subject matter.

The order in which the method 400 is described is not intended to be construed as a limitation, and any number of the described method blocks may be combined in any order to implement the method 400, or an alternative method. Furthermore, the method 400 may be implemented by processing resource(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. Further, although the method 400 may be implemented in a variety of systems, the method 400 is described in relation to the aforementioned system 100, for ease of explanation. In an example, the method 400 may be performed by a processing resource, such as the processor 102.

At block 402, a chaining instruction to chain a plurality of brokered service instances is received. The plurality of brokered service includes a first service instance and a second service instance, and may have to be chained for utilization by an application. The first service instance may be, for example, the first service instance 206 and the second service instance may be, for example, the second service instance 208. The first service instance is to be provisioned by a first service broker, such as the first service broker 210 and the second service instance is to be provisioned by a second service broker, such as the second service broker 212.

At block 404, based on the chaining instruction, a plurality of output parameters of the first service instance may be received. The output parameters include information that can be used to connect to the first service instance. The information may be the connection parameters as explained with reference to FIG. 3. For example, the output parameters may include the Uniform Resource Locator (URL) of the first service instance and user identifier (ID) and password corresponding to the first service instance.

At block 406, based on the chaining instruction, the plurality of output parameters is supplied as a plurality of input parameters to the second service broker. The second service broker may supply the plurality of input parameters to the second service instance. In an example, the plurality of output parameters may be supplied to the second service instance directly, instead of through the second service broker. The supplying of the parameters to the second service instance enables chaining the first service instance and the second service instance. For example, as explained with reference to FIG. 3, based on the connection parameters, the second service instance can connect to the first service instance, and such a connection can be used to facilitate flow of data from the first service instance to the second service instance.

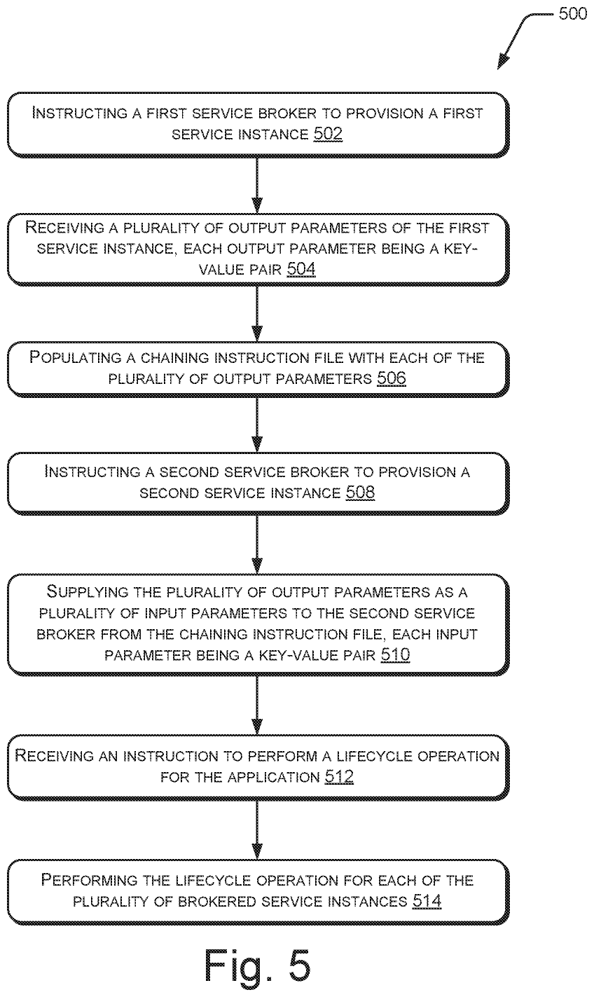

The various aspects of the method 400, in accordance with an example implementation, will be explained with reference to FIG. 5.

FIG. 5 illustrates a method 500 for chaining brokered service instances, according to an example implementation of the present subject matter.

The order in which the method 500 is described is not intended to be construed as a limitation, and any number of the described method blocks may be combined in any order to implement the method 500, or an alternative method. Furthermore, the method 500 may be implemented by processing resource(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. Further, although the method 500 may be implemented in a variety of systems, the method 500 is described in relation to the aforementioned system 100, for ease of explanation. In an example, the method 500 may be performed by a processing resource, such as the processor 102.

At block 502, the first service broker may be instructed to provision the first service instance. Upon provisioning of the first service instance, at block 504, the output parameters of the first service instance may be received.

In an example, the chaining instruction may be received in a chaining instruction file, such as the chaining instruction file 304. Further, at block 506, the chaining instruction file may be populated with the plurality of output parameters. and supplying the plurality of input parameters to the second service instance from the chaining instruction file. In an example, each of the plurality of output parameters is a key-value pair including a key and a value. For instance, as explained earlier, the first output parameter 314 is a key-value pair.

At block 508, the second service broker may be instructed to provision the second service instance. Further, at block 510, the input parameters may be supplied to the second service instance upon provisioning of the second service instance. The input parameters may be supplied from the chaining instruction file. In an example, each of the plurality of input parameters is a key-value pair including a key and a value. For instance, as explained earlier, the first input parameter 316 is a key-value pair.

In an example, the method 500 may include determining a correspondence between an output parameter of the plurality of output parameters and an input parameter of the plurality of input parameters based on a similarity between a key of the output parameter and a key of the input parameter. For instance, the method 500 may detect that the first output parameter 314 corresponds to the first input parameter 316 based on a similarity between the first key and the second key.

At block 512, an instruction may be received to perform a lifecycle operation for the application. The lifecycle operation may be, for example, an update operation or a delete operation. In response, at block 514, the lifecycle operation may be performed for each of the plurality of brokered service instances, such as the first service instance and the second service instance.

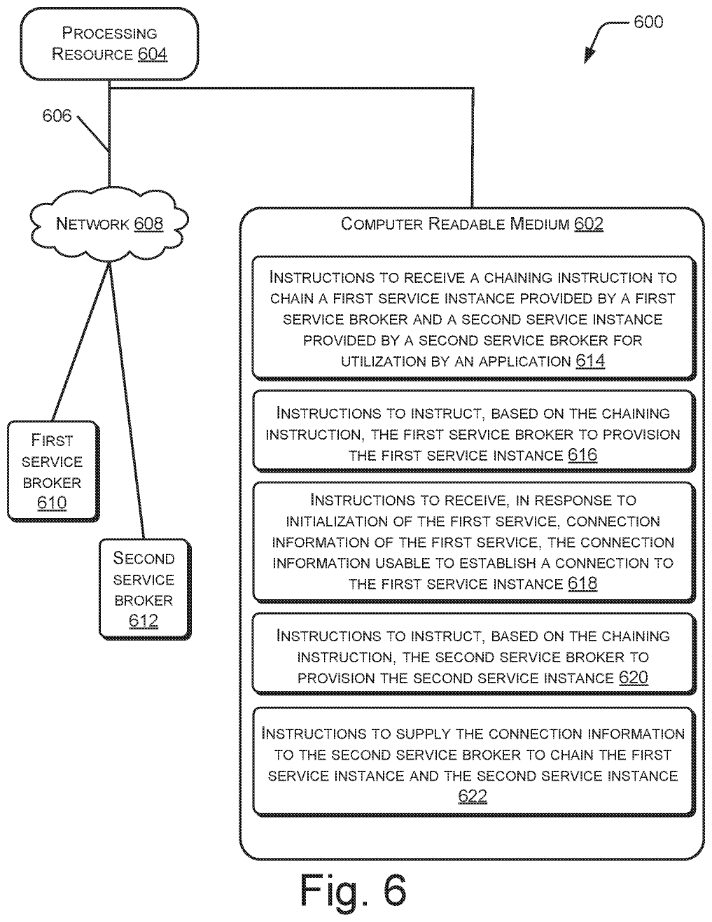

FIG. 6 illustrates a computing environment 600 implementing a non-transitory computer-readable medium 602 for chaining brokered service instances, according to an example implementation of the present subject matter.

In an example, the non-transitory computer-readable medium 602 may be utilized by a system, such as the system 100. The system 100 may be implemented in a public networking environment or a private networking environment. In an example, the computing environment 600 may include a processing resource 604 communicatively coupled to the non-transitory computer-readable medium 602 through a communication link 606.

In an example, the processing resource 604 may be implemented in a system, such as the system 100. The processing resource 604 may be the processor 102. The non-transitory computer-readable medium 602 may be, for example, an internal memory device or an external memory device. In one implementation, the communication link 606 may be a direct communication link, such as any memory read/write interface. In another implementation, the communication link 606 may be an indirect communication link, such as a network interface. In such a case, the processing resource 604 may access the non-transitory computer-readable medium 602 through a network 608. The network 608 may be a single network or a combination of multiple networks and may use a variety of different communication protocols.

The processing resource 604 and the non-transitory computer-readable medium 602 may also be communicatively coupled to service brokers 610 and 612 over the network 608. The service brokers 610 and 612 may be, for example, the first service broker 210 and the second service broker 212.

In an example implementation, the non-transitory computer-readable medium 602 includes a set of computer-readable instructions to chain brokered service instances. The set of computer-readable instructions can be accessed by the processing resource 604 through the communication link 606 and subsequently executed.

Referring to FIG. 6, in an example, the non-transitory computer-readable medium 602 includes instructions 614 that cause the processing resource 604 to receive a chaining instruction to chain a first service instance provided by a first service broker and a second service instance provided by a second service broker for utilization by an application. The first service instance, the first service broker, the second service instance, and the second service broker may be, for example, the first service instance 206, the first service broker 210, the second service instance 208, and the second service broker 212 respectively.

The non-transitory computer-readable medium 602 includes instructions 616 to instruct, based on the chaining instruction, the first service broker to provision the first service instance.

The non-transitory computer-readable medium 602 includes instructions 618 to receive, in response to initialization of the first service, connection information of the first service. The connection information can be used to establish a connection to the first service instance.

The non-transitory computer-readable medium 602 includes instructions 620 to instruct, based on the chaining instruction, the second service broker to provision the second service instance. Instructions 622 of non-transitory computer-readable medium 602 cause supplying the connection information to the second service broker. The second service broker may then send the connection information to the second service instance to chain the first service instance and the second service instance. In an example, the instructions 622 may cause supplying the plurality of output parameters to the second service instance directly, instead of through the second service broker.

In an example, the connection information may be a first value corresponding to a first key, and the first key and the first value may be part of a first key-value pair. The first key-value pair may be, for example, the first output parameter 314. The computer-readable medium 602 includes instructions to determine that the first key corresponds to a second key that is to be part of a second key-value pair to be supplied to the second service instance. The second key-value pair may be, for example, the first input parameter 316. The determination of the correspondence may be performed based on a similarity between the first key and the second key. In an example, the first key may be “user_ID” and the second key may be “DB_user_ID”, as explained earlier. Based on the determination of the correspondence, the instructions may cause generation of the second key-value pair including the second key and the first value, and supply it to the second service broker.

In an example, the chaining instruction may be received in a chaining instruction file, such as the chaining instruction file 304. Further, the computer-readable medium 602 may include instructions to populate the chaining instruction file with the connection information and supplying the connection information to the second service broker from the chaining instruction file.

Further, in an example, the computer-readable medium 602 may include instructions to receive an instruction to perform a lifecycle operation for the application. The lifecycle operation may be, for example, an update operation or a delete operation. In response, the instructions enable performing the lifecycle operation for each of the first service instance and the second service instance.

In an example, the connection information may be a password of the first service instance. The computer-readable medium 602 may include instructions to receive an instruction to update the password of the first service instance to a new password. In response, the first service instance may be instructed to update its password to the new password. In response to update of the password, the new password may be supplied to the second service instance to maintain chaining of the first service instance and the second service instance. The new password may be supplied to the second service instance, for example, through the second service broker.

The present subject matter provides an automated and efficient technique for chaining of brokered service instances. For instance, to chain a plurality of service instances for an application, a developer is to provide a chaining instruction having a list of the service brokers alone, and the techniques of the present subject matter perform various steps involved in the chaining, such as the instantiation of service instances, receiving output parameters, supplying input parameters, and the like. Also, the usage of off-the-shelf service instances considerably simplifies the application development process, as the developer is not to develop, install, configure, and maintain the service instances. Since the performance of the service instances are to be guaranteed by the providers of the service instances, the burden on the developer is reduced. Thus, the present subject matter enables developer to specify the service instances to be chained for an application in a declarative manner, and accordingly chains the service instances. Also, the present subject matter prevents the developer from having to write separate chaining instruction files for each service instance that is to be involved in an application.

The utilization of the catalogs of service brokers to determine parameters of service instances, receiving the values of the output parameters, and mapping the output parameters to input parameters of the subsequent service instances provides a dynamic manner of conveying parameters among services for their chaining.

Also, the present subject matter enables managing all services utilized by an application collectively. For instance, lifecycle operations, such as update and delete, of all service instances involved in an application can be performed together. Thus, the developer is not to be aware of the procedure to perform the lifecycle operations for each service instance involved in the application. The update of the service instances collectively ensures that no two service instances are incompatible with each other.

Further, the present subject matter can be utilized for service brokers compliant with the OSB API standard, which is widely used for provisioning of brokered service instances. Therefore, the present subject matter can be utilized in the provisioning of brokered service instances without substantial adaptations or modifications to the existing service brokers or application deployment systems. Further, the usage of a well-known format, such as JSON format or YAML format, for receiving the chaining instruction prevents the developer from having to learn a new language for providing the chaining instruction.

The present subject matter can also facilitate modifying a chain of service instances. For instance, if a developer wants to replace a service instance on the chain with another service instance, the developer may simply provide a new chaining instruction, and the techniques of the present subject matter can modify the chain of service instances and deploy them for utilization by the application. Also, an existing chain of service instances can be modified and reused for development of a new application.

Although implementations of chaining of brokered service instances have been described in language specific to structural features and/or methods, it is to be understood that the present subject matter is not necessarily limited to the specific features or methods described. Rather, the specific features and methods are disclosed and explained as example implementations.

We claim:

1. A system comprising:
a processor; and
a memory coupled to the processor and storing instructions executable by the processor to:
receive a chaining instruction to chain a first service instance to be provisioned by a first service broker and a second service instance to be provisioned by a second service broker for utilization by an application;
instruct, in response to receiving the chaining instruction, the first service broker to provision the first service instance;
instruct, in response to receiving the chaining instruction, the second service broker to provision the second service instance;
receive a first output parameter of the first service instance; and
supply a first input parameter comprising at least a part of the first output parameter to the second service broker to chain the first service instance and the second service instance.

2. The system of claim 1, wherein the first output parameter is a connection parameter usable to connect to the first service instance.

3. The system of claim 1, wherein the first output parameter is a first key-value pair having a first key and a first value, wherein the first input parameter is to have a second key, and wherein the instructions are executable by the processor to:
determine that the first key corresponds to the second key based on a similarity between the first key and the second key; and
generate the first input parameter as a second key-value pair having the second key and the first value.

4. The system of claim 1, wherein
the first output parameter is one of a plurality of output parameters of the first service instance,
the second service instance comprises a plurality of input parameters, the plurality of input parameters comprising the first input parameter, and
the instructions are executable by the processor to map the plurality of output parameters to the plurality of input parameters.

5. The system of claim 1, wherein
the first output parameter is one of a plurality of output parameters of the first service instance,
the second service instance comprises a plurality of input parameters, the plurality of input parameters comprising the first input parameter,
each of the plurality of output parameters and each of the plurality of input parameters is a key-value pair, and
the instructions are executable by the processor to:
determine a key of each of the plurality of output parameters based on a catalog of the first service broker; and
determine a key of each of the plurality of input parameters based on a catalog of the second service broker.

6. The system of claim 1, wherein
the first output parameter is one of a plurality of output parameters of the first service instance,
the second service instance comprises a plurality of input parameters, the plurality of input parameters comprising the first input parameter,
the chaining instruction is received in a chaining instruction file, and
the instructions are executable by the processor to:
populate the chaining instruction file with each of the plurality of output parameters; and
supply the plurality of input parameters to the second service broker from the chaining instruction file.

7. The system of claim 1, wherein the instructions are executable to:
receive an instruction to perform a lifecycle operation for the application; and
perform the lifecycle operation for each of the first service instance and the second service instance.

8. The system of claim 1, wherein the instructions are executable to:
receive an instruction to perform an update operation for the application;
update the first service instance from an earlier version of the first service instance to a later version of the first service instance;
in response to failure to update the second service instance from an earlier version of the second service instance to a later version of the second service instance, detect whether the later version of the first service instance is incompatible with the earlier version of the second service instance; and
in response to detection of incompatibility, roll-back update for the first service instance.

9. The system of claim 1, wherein the system is to interact with each of the first service broker, the second service broker, the first service instance, and the second service instance using Open service broker (OSB) Application programming interface (API).

10. A method comprising:
receiving, by a processing resource, a chaining instruction to chain a plurality of brokered service instances for utilization by an application, the plurality of brokered service instances comprising a first service instance and a second service instance, wherein the first service instance is to be provisioned by a first service broker and the second service instance is to be provisioned by a second service broker;
receiving, by the processing resource, based on the chaining instruction, a plurality of output parameters of the first service instance, the plurality of output parameters comprising information usable by the second service instance to connect to the first service instance; and
supplying, by the processing resource, based on the chaining instruction, the plurality of output parameters as a plurality of input parameters to the second service broker to chain the first service instance and the second service instance.

11. The method of claim 10, comprising:
instructing, based on the chaining instruction, the first service broker to provision the first service instance; and
instructing, based on the chaining instruction, the second service broker to provision the second service instance.

12. The method of claim 10, wherein the chaining instruction is received in a chaining instruction file, and wherein the method comprises:
populating the chaining instruction file with each of the plurality of output parameters; and
supplying the plurality of input parameters to the second service broker from the chaining instruction file.

13. The method of claim 10, wherein each of the plurality of output parameters and each of the plurality of input parameters is a key-value pair comprising a key and a value and the method comprises determining a correspondence between an output parameter of the plurality of output parameters and an input parameter of the plurality of input parameters based on a similarity between a key of the output parameter and a key of the input parameter.

14. The method of claim 10, comprising:
receiving an instruction to perform a lifecycle operation for the application; and
perform the lifecycle operation for each of the plurality of brokered service instances.

15. The method of claim 10, wherein the plurality of output parameters comprises a uniform resource locator (URL) of the first service instance, a user identifier (ID) corresponding to the first service instance, and a password corresponding to the first service instance.

16. A non-transitory computer-readable medium comprising instructions, the instructions being executable by a processing resource to:
receive a chaining instruction to chain a first service instance provisioned by a first service broker and a second service instance provisioned by a second service broker for utilization by an application;
instruct, based on the chaining instruction, the first service broker to provision the first service instance;
receive, in response to initialization of the first service, connection information of the first service instance, the connection information usable to establish a connection to the first service instance;
instruct, based on the chaining instruction, the second service broker to provision the second service instance; and
supply the connection information to the second service broker to chain the first service instance and the second service instance.

17. The non-transitory computer-readable medium of claim 16, wherein the instructions are executable by the processing resource to:
receive the connection information as a first value corresponding to a first key, the first key and the first value being part of a first key-value pair;
determine that the first key corresponds to a second key based on a similarity between the first key and the second key, wherein the second key is to be part of a second key-value pair to be supplied to the second service instance; and
generate the second key-value pair comprising the second key and the first value.

18. The non-transitory computer-readable medium of claim 16, wherein the instructions are executable by the processing resource to:
receive an instruction to perform a lifecycle operation for the application; and
perform the lifecycle operation for each of the first service instance and the second service instance.

19. The non-transitory computer-readable medium of claim 16, wherein the connection information is a password and wherein the instructions are executable by the processing resource to:
receive an instruction to update the password of the first service instance to a new password;
instruct the first service instance to update its password to the new password; and
in response to update of the password, supply the new password to the second service broker to maintain chaining of the first service instance and the second service instance.

20. The non-transitory computer-readable medium of claim 16, wherein the instructions are executable by the processing resource to:
receive the chaining instruction in a chaining instruction file;
populate the chaining instruction file with the connection information; and
supply the connection information to the second service broker from the chaining instruction file.
